(19) United States
(12) Patent Application Publication
(10) Pub. No.: US 2011/0112894 A1
(43) Pub. Date: May 12, 2011

(54) METHOD AND SYSTEM FOR IMPLEMENTING INTERACTIVE ADVERTISEMENTS, TERMINAL EQUIPMENT, AND ADVERTISEMENT CLIENT TERMINAL

(76) Inventors: Yinyan Tan, Shenzhen (CN); Gang Shao, Shenzhen (CN); Jinjing Zhan, Shenzhen (CN)

(21) Appl. No.: 13/008,543

(22) Filed: Jan. 18, 2011

Related U.S. Application Data
(63) Continuation of application No. PCT/CN2009/071521, filed on Apr. 28, 2009.

(30) Foreign Application Priority Data
Jul. 18, 2008 (CN) 200810133890.8

(51) Int. Cl. G06Q 30/00

(52) U.S. Cl. 705/14.4

(57) ABSTRACT

A method and a system for implementing interactive advertisements, and an advertisement client terminal in a terminal equipment are provided. The method for implementing interactive advertisements includes: receiving, by an advertisement client terminal, a request message sent by a service client terminal, in which the request message is configured to request information interaction with a third party platform publishing advertisements; acquiring, by the advertisement client terminal, contact information of the third party platform according to the request message; and triggering, by the advertisement client terminal, a terminal communication module to perform information interaction with the third party platform according to the contact information of the third party platform. The method avoids congestion at an advertisement server without changing existing processing operations of a network-side communication module, and enables the advertisement client terminal to detect and filter malicious clicks, to perform precise, reliable, and true charging of interactive advertisements by category, and to shield user information from a network side.

### CROSS-REFERENCE TO RELATED APPLICATIONS

The application is a continuation of International Application No. PCT/CN2009/071521, filed on Apr. 28, 2009, which claims priority to Chinese Patent Application No. 200810133890.8, filed on Jul. 18, 2008, both of which are hereby incorporated by reference in their entireties.

### FIELD

The present disclosure relates to the field of network communication technology, and more particularly to a method and a system for implementing interactive advertisements, a terminal equipment, and an advertisement client terminal.

### BACKGROUND

An interactive advertisement in a communication system refers to any advertisement requiring or permitting a user to take an action. The action taken by the user includes: playing games, filling information, answering questions, buying goods, permitting the buyer to contact the advertiser, permitting contact with the buyer, acquiring more information, and the like.

Currently, one method for implementing interactive advertisements is as follows. A service client terminal implements information interaction between a user terminal and a third party platform (such as a seller platform) publishing advertisements by invoking a terminal communication module.

Another method for implementing interactive advertisements is as follows. An advertisement platform implements information interaction between a user terminal and a third party platform publishing advertisements by triggering a network-side communication module.

However, in the implementation of the present disclosure, the inventors find that the prior art at least has the following problems.

In the method of implementing information interaction by invoking the terminal communication module, the information interaction situation between the user and the third party platform acquired by an advertisement platform from the terminal communication module cannot reflect the service triggering the information interaction process. As a result, the advertisement platform cannot collect information statistics on interactive advertisements by category, and thus cannot perform precise charging of them by category; the advertisement platform cannot detect the malicious click behavior, or since the malicious click behavior exists and the method cannot control malicious clicks, the charging of interactive advertisements is unreliable.

In the method for the advertisement platform to implement information interaction by triggering the network-side communication module, processing operations of the network-side communication module are changed; besides, both the advertisement platform and the network-side communication module can know information such as user contact methods and the user's advertisement requirements, which results in poor controllability (for example, poor safety) to user privacy information; although an advertisement server can detect the malicious click behavior, the behavior can be detected only at the network side, so transmission resources of the user and the network side are occupied, and processing resources of the advertisement server are greatly occupied; the advertisement server needs to process an advertisement request message of each service client terminal, which easily causes congestion at the advertisement server.

### SUMMARY OF THE DISCLOSURE

In view of this, the present disclosure is directed to a method and a system for implementing interactive advertisements, a terminal equipment, and an advertisement client terminal, so as to enable collection of information statistics on interactive advertisements, check and filtering of malicious clicks, and precise charging of the interactive advertisements; and meanwhile to avoid congestion at an advertisement platform and ease the processing burden of the advertisement platform.

In an embodiment, the present disclosure provides a method for implementing interactive advertisements, which includes the following steps.

An advertisement client terminal receives a request message sent by a service client terminal. The request message is configured to request information interaction with a third party platform publishing advertisements.

The advertisement client terminal acquires contact information of the third party platform according to the request message.

The advertisement client terminal triggers a terminal communication module to perform information interaction with the third party platform according to the contact information of the third party platform.

In an embodiment, the present disclosure provides a system for implementing interactive advertisements, which includes a service client terminal, an advertisement client terminal, a terminal communication module, and a third party platform.

The service client terminal is configured to send a request message according to an advertisement clicked. The request message is configured to request information interaction with the third party platform.

The advertisement client terminal is configured to receive the request message, acquire contact information of the third party platform according to the request message, and trigger the terminal communication module according to the contact information of the third party platform.

The terminal communication module is configured to perform the information interaction with the third party platform according to the triggering.

The third party platform is configured to publish the advertisements and perform the information interaction with the terminal communication module.

In an embodiment, the present disclosure provides a terminal equipment, which includes a service client terminal, an advertisement client terminal, and a terminal communication module.

The service client terminal is configured to send a request message according to an advertisement clicked. The request message is configured to request information interaction with a third party platform publishing advertisements.

The advertisement client terminal is configured to receive the request message, acquire contact information of the third party platform according to the request message, and trigger the terminal communication module according to the contact information of the third party platform.

The terminal communication module is configured to perform the information interaction with the third party platform according to the triggering.

In an embodiment, the present disclosure provides an advertisement client terminal, which includes an interaction recording module, an advertisement information module, and an interaction request receiving module.

The interaction recording module is configured to store a history interaction record of information interaction that has been performed between the advertisement client terminal and a third party platform.

The advertisement information module is configured to store contact information of the third party platform and an interaction limiting condition.

The interaction request receiving module is configured to receive a request message sent from a service client terminal, acquire the history interaction record from the interaction recording module, acquire the interaction limiting condition from the advertisement information module, and determine whether the history interaction record conforms to the interaction limiting condition, and if yes, trigger a terminal communication module according to contact methods of the third party platform acquired from the advertisement information module, and add information to the interaction recording module according to the request message and the triggering; otherwise, prohibit information interaction. The request message is configured to request the information interaction with the third party platform publishing advertisements.

It can be known from the description of the above technical solutions that, in the embodiments of the present disclosure, the advertisement client terminal is configured to trigger the terminal communication module to establish a session with the third party platform publishing advertisements, so as to implement an information interaction process, so that the advertisement client terminal knows which service triggers the information interaction process of an interactive advertisement, and acquires an overall information interaction situation, so as to enable precise charging of interactive advertisements by category and avoid congestion at an advertisement server. In addition, since the advertisement client terminal can receive a request message requesting information interaction with the third party platform publishing advertisements, the above technical solutions enable detection and filtering of malicious clicks, reliable and true charging of interactive advertisements, and shielding of information such as user contact methods and the user's advertisement requirements.

### BRIEF DESCRIPTION OF THE DRAWINGS

FIG. 1 is a flow chart of a method for implementing interactive advertisements in a first embodiment of the present disclosure;

FIG. 2 is a schematic view illustrating signaling interaction of a method for implementing interactive advertisements in a second embodiment of the present disclosure;

FIG. 3 is a flow chart of the method for implementing interactive advertisements in the second embodiment of the present disclosure;

FIG. 4 is a schematic structural view of a system for implementing interactive advertisements in a fourth embodiment of the present disclosure; and

FIG. 5 is a flow chart of a method for acquiring a history interaction record in a fifth embodiment of the present disclosure.

### DETAILED DESCRIPTION OF THE EMBODIMENTS

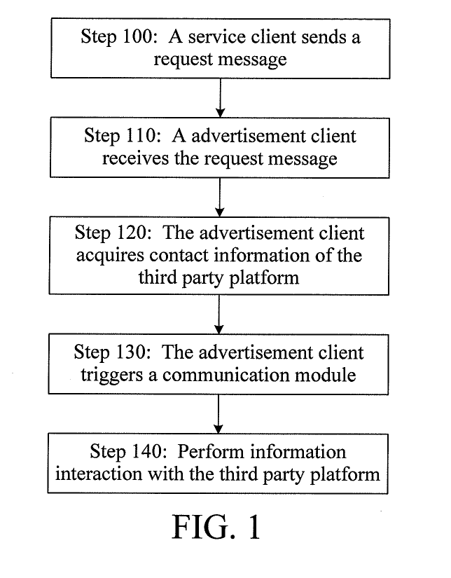

In a first embodiment, a method for implementing interactive advertisements is provided. The process of the method is as shown in FIG. 1.

Referring to FIG. 1, in Step 100, a service client terminal sends a request message according to a user's click of an interactive advertisement, so as to request information interaction between the user and a third party platform (for example, a seller platform) publishing the clicked advertisement. For example, the request message is configured to request information interaction with the third party platform publishing the clicked advertisement. The request message may carry interaction type information and advertisement identification (ID) information of the clicked advertisement. The interaction type information is, for example, a conversation mode, an instant message (IM) mode, or the like. The advertisement ID information is configured to identify the advertisement. The request message may further carry a service ID of the advertisement. The service ID enables an advertisement client terminal to know the source of the request message. Certainly, the advertisement client terminal may also identify the source of the request message in other ways, for example, through the type of a protocol employed by the request message.

In Step 110, the advertisement client terminal receives the request message sent by the service client terminal. In the case that the request message carries the service ID, the advertisement client terminal can process the request message when determining that the service ID is a service ID recognized by the advertisement client terminal; otherwise, the advertisement client terminal does not process the request message.

In Step 120, the advertisement client terminal acquires contact information of the third party platform according to the information carried in the request message. For example, the advertisement client terminal may acquire the contact information of the third party platform corresponding to the advertisement ID in the request message according to pre-stored corresponding relations between advertisement IDs and contact information of the third party platform. For another example, the advertisement client terminal may acquire the contact information of the third party platform corresponding to the advertisement ID and the interaction type information in the request message according to pre-stored corresponding relations between advertisement IDs as well as interaction type information and contact information of the third party platform. Certainly, the request message may also carry the contact information of the third party platform. At this time, the advertisement client terminal may also acquire the contact information of the third party platform directly from the request message. In addition, the advertisement client terminal may also request the contact information of the third party platform from a network side. For example, the advertisement client terminal requests the contact information of the third party platform from the network side directly after receiving the request message, or requests the contact information of the third party platform from the network side when the contact information of the third party platform cannot be acquired from a terminal side.

Since the contact information of the third party platform often includes multiple different contact methods, such as different contact methods corresponding to the same advertisement ID, contact methods of different interaction types corresponding to the same advertisement ID, and contact methods of different time periods and different places corresponding to the same advertisement ID, the advertisement client terminal may select an appropriate contact method of the third party platform for the current information interaction of the user from all the contact methods of the third party platform according to an interaction type of the user and/or a current state of the user when acquiring the contact information of the third party platform. The current state of the user is, for example, a current time, a position of the user at the current time, and so on.

It should be noted that, in Step 120, the advertisement client terminal may perform an operation of detecting and filtering malicious clicks according to pre-stored history interaction records and interaction limiting condition information. The interaction limiting condition information is a condition limiting interaction. From the opposite point of view, the interaction limiting condition information is condition information set for determining whether interaction is permitted; that is to say, the interaction limiting condition may also be referred to as an interaction permissive condition. The operation of detecting and filtering malicious clicks may be as follows. The advertisement client terminal acquires an interaction limiting condition of the seller platform, for example, the third party platform, from the pre-stored interaction limiting condition information according to the advertisement ID or according to the advertisement ID and the interaction type information, and the advertisement client terminal acquires a history interaction record of information interaction performed between the user and the third party platform from the pre-stored history records according to the advertisement ID or according to the advertisement ID and the interaction type information. Then, the advertisement client terminal determines whether the acquired history interaction record conforms to the acquired interaction limiting condition. After determining that the acquired history interaction record is not up to the acquired interaction limiting condition (for example, the history interaction record conforms to the interaction condition), the advertisement client terminal acquires the contact information of the third party platform. Otherwise, the advertisement client terminal may not perform the operation of acquiring the contact information of the third party platform, and directly terminates the current process of implementing the interactive advertisement, for example, prohibits the current information interaction process of the interactive advertisement. The pre-stored interaction limiting conditions may be requested and acquired by the advertisement client terminal from the network side according to advertisement Ids or may be stored in the advertisement client terminal.

Certainly, the above operation of determining whether the history interaction record conforms to the interaction limiting condition may also be performed after the contact information of the third party platform is acquired. That is to say, the advertisement client terminal directly terminates the current process of implementing the interactive advertisement after determining that the history interaction record does not conform to the interaction limiting condition, and the advertisement client terminal directly proceeds to Step 130 after determining that the history interaction record conforms to the interaction limiting condition.

The pre-stored interaction limiting conditions may be a maximum permissible interaction frequency, or, certainly, other content such as a maximum permissible number of interaction times.

The above pre-stored history interaction records may be divided into two parts of content according to the time period when a history interaction record is stored. One part of content is information recorded and stored by the advertisement client terminal when deciding to trigger a terminal communication module, for example, information in the information interaction process. The other part of content is information acquired by the advertisement client terminal from the terminal communication module after the current information interaction is completed, for example, interaction result information of the current information interaction. The information recorded and stored by the advertisement client terminal when deciding to trigger the terminal communication module, for example, the information in the information interaction process, may include information such as an interaction type and/or an advertisement ID and/or a contact method of the third party platform and/or a moment (for example, a trigger moment). The interaction result information includes information such as an interaction state indicating whether communication is successful, a conversation duration, a time span and/or times that the user sends an IM.

The advertisement client terminal may acquire interaction result information from the terminal communication module periodically or according to other trigger conditions. For example, the advertisement client terminal acquires interaction result information that has not been obtained (for example, new interaction result information) from the terminal communication module upon receiving the request message sent from the service client terminal. Certainly, the terminal communication module may also actively send the new interaction result information stored therein to the advertisement client terminal. For example, the terminal communication module may send the new interaction result information stored therein to the advertisement client terminal periodically or after the information interaction between the user and the third party platform ends.

In Step 130, the advertisement client terminal triggers the terminal communication module according to the acquired contact information of the third party platform.

In Step 130, the advertisement client terminal may first perform an operation of determining whether to shield user information from the network side, and then decide how to perform the operation of triggering the terminal communication module according to a result of the determining operation. For example, the advertisement client terminal may acquire interaction policy information of the user after acquiring the contact information of the third party platform, and the advertisement client terminal determines whether to provide user information to the network side according to the interaction policy information. If the advertisement client terminal determines that the user information is not provided to the network side, the advertisement client terminal may instruct the terminal communication module to shield the user information in the triggering process; if the advertisement client terminal determines that the user information can be provided to the network side, the advertisement client terminal may trigger the terminal communication module directly without performing the above notification processing operation. The above user information may include contact methods of the user or contact methods of the user and current state information of the user. The above process for acquiring the interaction policy information of the user may also be performed before the advertisement client terminal acquires the contact information of the third party platform.

In Step 140, the terminal communication module performs information interaction with the third party platform according to the triggering of the advertisement client terminal. For example, the terminal communication module establishes a communication connection between the user and the third party platform according to contact methods of the third party platform, and then, the user and the third party platform may perform information interaction according to the established connection. For another example, the terminal communication module directly sends an IM of the user to the third party platform according to the contact methods of the third party platform.

In the above embodiment described with reference to FIG. 1, the advertisement client terminal is configured to trigger the terminal communication module to establish a session with the third party platform publishing advertisements so as to implement an information interaction process, which provides a new process for implementing interactive advertisements. The above implementation process enables the advertisement client terminal to know the service based on which information interaction is triggered, and enables the advertisement client terminal to acquire an overall information interaction situation, for example, to know a service based on which a certain information interaction process is triggered, without changing existing processing operations of a network-side communication module, so that an advertisement server can perform precise charging of interactive advertisements by category, and congestion at the advertisement server can be avoided. In addition, since the advertisement client terminal controls the interaction process of interactive advertisements by using history interaction records and interaction limiting conditions, the advertisement client terminal can detect and filter malicious clicks; the advertisement client terminal can shield user information such as user contact methods and the user's advertisement requirements from the network by using interaction policy information, thereby ensuring safety of the user information.

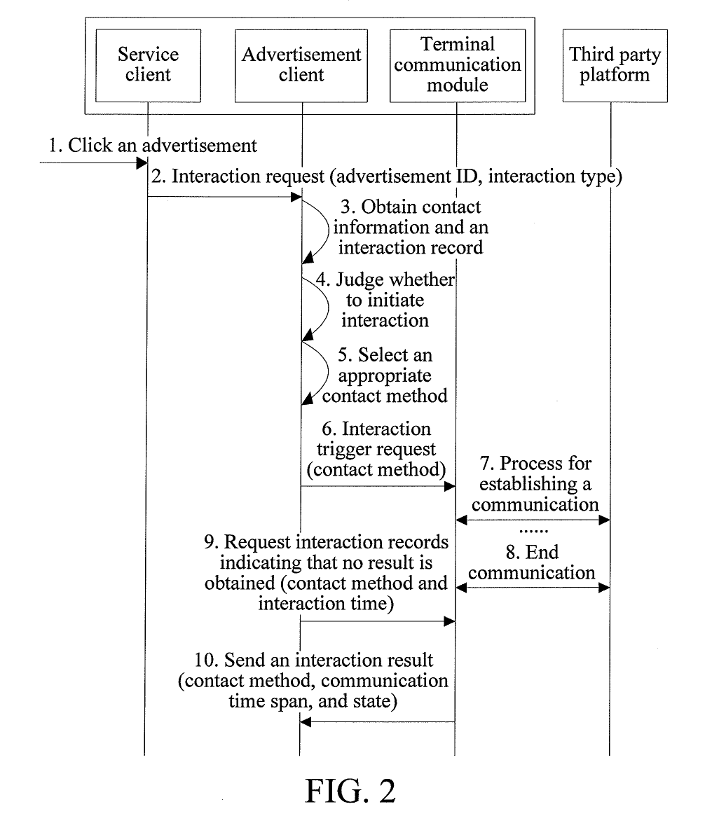

In a second embodiment, a method for implementing interactive advertisements is provided. The process of the method is as shown in FIG. 2.

In FIG. 2, in Step 1, a user clicks an interactive advertisement through a service client terminal, and requests information interaction with a third party platform publishing the clicked interactive advertisement. The service client terminal can determine an interaction type and an advertisement ID of the clicked interactive advertisement through the click. The interaction type includes a conversation mode, an IM mode, a short message mode, a multimedia message mode, and the like.

In Step 2, the service client terminal sends a request message (for example, an interaction request in FIG. 2) to an advertisement client terminal, so as to request information interaction between the user and the third party platform publishing the clicked interactive advertisement. The request message may include an interaction type and the advertisement ID of the clicked interactive advertisement. The request message may further carry a service ID of the advertisement.

In Step 3, the advertisement client terminal receives the request message, and searches for and acquires a history interaction record between the user and the third party platform publishing the clicked interactive advertisement from pre-stored history interaction records according to the advertisement ID in the request message or the advertisement ID and the interaction type in the request message, and searches for and acquires an interaction limiting condition of the interactive advertisement from pre-stored interaction limiting conditions. The history interaction record acquired by the advertisement client terminal may be a history interaction record in a certain period, for example, a history interaction record in a week or a history interaction record in a day. The above interaction limiting condition may also be referred to as seller information or advertisement information. The interaction limiting condition of the interactive advertisement acquired by the advertisement client terminal is, for example, a maximum permissible interaction frequency (5 times per day and/or once per minute). The pre-stored history interaction records may include a record number (for example, a serial number of a history interaction record), an advertisement ID, interaction type information (for example, conversation, IM, and so on), a contact method of the third party platform, an interaction state (for example, whether the interaction between the user and the third party platform is successful or fails), and may further include one or more of information such as a moment (for example, the moment when a terminal communication module is triggered), interaction time span and times (for example, an interaction time span of a conversation, times that the terminal communication module sends an IM to the third party platform), and whether an interaction result is obtained (for example, whether an interaction result is acquired from the terminal communication module). In the following embodiments, the interaction time span or the times may be represented as time span/times.

In Step 4, the advertisement client terminal determines the history interaction record and the interaction limiting condition that are acquired, and if the advertisement client terminal determines that the acquired history interaction record is already up to the acquired interaction limiting condition, the current click of the interactive advertisement by the user is a click exceeding the maximum permissible interaction frequency, and the advertisement client terminal may terminate the current process of the clicked interactive advertisement and notify the user; if the acquired history record is not up to the acquired interaction limiting condition, the advertisement client terminal may perform subsequent processing operations, and the process proceeds to Step 5.

In Step 5, the advertisement client terminal selects a contact method of the third party platform for the user, for example, a contact method of the third party platform suitable for user conversation, from all contact methods of the third party platform publishing the clicked advertisement according to an interaction type of the user and/or a current state (for example, a current position and a current time) of the user.

All contact method information of the third party platform may be stored with the interaction limiting conditions, for example, the pre-stored advertisement information may contain the interaction limiting conditions and all the contact methods of the third party platform.

The advertisement client terminal may determine all the contact methods of the third party platform publishing the clicked advertisement according to the advertisement ID of the clicked advertisement.

The advertisement client terminal may first acquire all the contact methods of the third party platform publishing the clicked advertisement according to the advertisement ID, and then select a contact method from all the contact methods according to the interaction type of the user and/or the current state of the user. The advertisement client terminal may also search for and obtain a contact method of the third party platform from the advertisement information directly according to the advertisement ID, and the current state and interaction type of the user.

The advertisement client terminal may further acquire preset interaction policy information of the user and determine whether to provide user information to the network side according to the interaction policy information, for example, determine whether contact methods of the user and current state information of the user need to be provided to the network side.

In Step 6, the advertisement client terminal sends the interaction request message to the terminal communication module, so as to trigger information interaction between the terminal communication module and the third party platform. For example, the terminal communication module first establishes a communication connection for a conversation of the current information interaction, and then performs information interaction based on the communication connection. Interaction request parameters in the interaction request message may include contact method information of the third party platform selected in Step 5. If it is determined not to provide the user information to the network side in Step 5, the interaction request parameters may further contain notification information of not providing the user information to the network side. The advertisement client terminal may add information to the history interaction record according to the current trigger operation. For example, the advertisement client terminal may add information containing a record number, interaction type information, an advertisement ID, a contact method of the third party platform, a trigger moment, and whether an interaction result is obtained to the history interaction record, and the information may be added in the form of entries. At this time, the added information indicating whether an interaction result is obtained should indicate that no interaction result is obtained.

In Step 7, the terminal communication module performs information interaction with the third party platform. For example, for an interaction type of the conversation mode, the terminal communication module establishes a communication connection between the user and the third party platform according to the triggering of the advertisement client terminal, and the user performs communication, for example, information interaction, with the third party platform based on the successfully established communication connection.

In Step 8, the information interaction ends, and the communication between the terminal communication module and the third party platform ends. For the interaction type of the conversation mode, the communication connection between the user and the third party platform is disconnected when the communication between the user and the third party platform ends.

This embodiment may further include acquiring result information of the information interaction by the advertisement client terminal.

In Step 9, the advertisement client terminal requests interaction result information of history interaction records without interaction results in the history interaction records (for example, a history interaction record table) from the terminal communication module (for example, a terminal conversation module or a terminal IM module) according to a time period or event triggering. For example, the advertisement client terminal determines that each record with information indicating whether an interaction result is obtained indicates no interaction result is obtained in the history interaction records, determines a moment and a contact method of the third party platform in each record, and sends a request message for acquiring an information interaction result to the terminal communication module, so as to request interaction result information of each history interaction record from the terminal communication module.

In Step 10, the terminal communication module returns the interaction result information to the advertisement client terminal according to the request of the advertisement client terminal, and the advertisement client terminal adds the interaction result information returned by the terminal communication module to a corresponding record (for example, a corresponding entry) of the history interaction record. For the interaction result request message, the message returned by the terminal communication module to the advertisement client terminal may include a contact method of the third party platform and an interaction state, and may further include interaction moment and/or interaction time span information. The advertisement client terminal may search for the corresponding entry in the history interaction records according to the returned message, for example, according to the contact method of the third party platform or according to the contact method and the interaction moment, and add the interaction state and/or interaction time span information in the returned message to the found entry. When adding the returned interaction result information to the history interaction record, the advertisement client terminal sets whether an interaction result is obtained in the corresponding record as the interaction result is obtained.

In the above embodiment described with reference to FIG. 2, the advertisement client terminal is configured to trigger the terminal communication module to establish a session with the third party platform publishing advertisements so as to implement an information interaction process, which enables the advertisement client terminal to know the service based on which the information interaction process of an interactive advertisement is triggered, and enables the advertisement client terminal to acquire an overall information interaction situation, for example, to know a service based on which the information interaction process of an interactive advertisement is triggered, without changing existing processing operations of a network-side communication module, so that the network side, for example, an advertisement server, can perform precise charging of interactive advertisements by category, and congestion at the advertisement server can be avoided. In addition, since the advertisement client terminal controls the interaction process of interactive advertisements by using history interaction records and interaction permissive conditions, the advertisement client terminal can detect and filter malicious clicks; the advertisement client terminal can shield user information such as user contact methods and the user's advertisement requirements from the network by using interaction policy information, thereby ensuring safety of the user information.

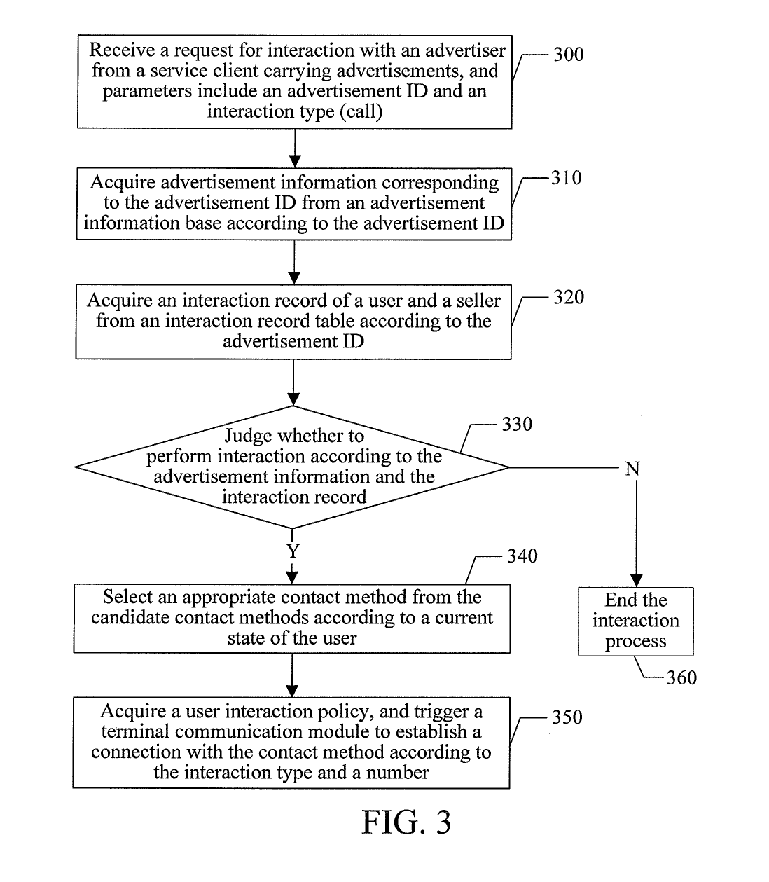

The second embodiment of the method for implementing interactive advertisements is illustrated below with reference to FIG. 3.

Referring to FIG. 3, in Step 300, an advertisement client terminal receives a request message for communication (for example, information interaction) with a third party platform publishing advertisements that is sent by a service client terminal bearing advertisements. Parameters in the request message include an advertisement ID and an interaction type, and may further include a service ID bearing advertisements.

In Step 310, the advertisement client terminal acquires the advertisement ID from the request message, and searches for corresponding advertisement information in an advertisement information base storing interaction permissive conditions according to the advertisement ID. The found advertisement information should include: contact information of the third party platform, maximum permissible interaction frequency information, and so on. The contact information of the third party platform may include contact information of multiple different contact methods, for example, different contact methods of the third party platform in the case of different interaction types, different positions, and different time.

In Step 320, the advertisement client terminal searches for a history interaction record of information interaction performed between a user terminal and the third party platform in a history interaction record base according to the advertisement ID, and may select a history interaction record in a certain period.

In Step 330, the advertisement client terminal determines whether to perform information interaction according to the found interaction limiting condition and history interaction record. The advertisement client terminal may determine whether the number of records of successful interaction in a certain period is smaller than the maximum permissible interaction frequency according to the maximum permissible interaction frequency in the interaction limiting condition and/or the found record of information interaction performed in a certain period, and if not, Step 360 is performed, in which the advertisement client terminal ends the current information interaction process between the user and the third party platform (for example, prohibits information interaction between the user and the third party platform), and notifies the user; otherwise, Step 340 is performed.

In Step 340, further, the advertisement client terminal may select an appropriate contact method from the contact methods of the third party platform according to an interaction type of the user and/or a current state (for example, time and position) of the user. The advertisement client terminal adds a corresponding record to the history interaction record (for example, a history interaction record table), so as to record information indicating that the current information interaction has been initiated but an interaction result is not obtained.

In Step 350, the advertisement client terminal may further acquire user interaction policy information, the advertisement client terminal determines whether to shield user information from the third party platform according to the user interaction policy information, and triggers a terminal communication module to establish a communication connection between the user and the third party platform according to a determinment result, the interaction type, and the contact method of the third party platform (for example, a contact number of the third party platform).

The above pre-stored history interaction records may exist in the form of a table, for example, the pre-stored history interaction records may be an interaction record table. The interaction record table may be stored in or independent of the advertisement client terminal. A specific example of the interaction record table is Table 1.

TABLE 1

| | | | Contact Method | | | | Whether an |
|---|---|---|---|---|---|---|---|
| Record | Interaction | Advertise- | of the Third | Interaction | | Time | Interaction |
| Number | Type | ment ID | Party Platform | State | Moment | Span/Times | Result Is Obtained |
| 001 | IM | 001 | ******** | Successful | 08:30 | 5 times | Yes |
| 002 | Call | 001 | 0755****1 | Successful | 10:35 | 3.34 min | Yes |
| 003 | Call | 002 | 0755****3 | | 12:00 | | No |

The interaction state in Table 1 represents whether the terminal communication module establishes the communication connection between the user and the third party platform successfully.

The meaning of the records in Table 1 is illustrated below with a specific example. At 08:30, the user begins to perform IM information interaction with the third party platform publishing an advertisement ID of 001 through a contact method of ********, and performs information interaction successfully; in the current interaction process, the user sends IMs to the third party platform for 5 times. In addition, entries with record numbers of 001 and 002 are history interaction records indicating that interaction results have been obtained from the terminal communication module, and the entry with a record number of 003 is a history interaction record indicating that no interaction result has been obtained from the terminal communication module.

An example of storing a history interaction record indicating that no interaction result is obtained is as follows. When receiving the request sent from a service client terminal and preparing to trigger the terminal communication module or having triggered the terminal communication module, the advertisement client terminal stores a record number, an interaction type, an advertisement ID, a contact method of the third party platform, a moment, and information indicating whether an interaction result is obtained in the interaction record table, and the information indicating whether an interaction result may be stored as No.

An example of storing a history interaction record indicating that an interaction result has been obtained is as follows. The advertisement client terminal obtains communication result information from the terminal communication module, adds an interaction state, a time span/times, and other content to a corresponding entry in the interaction record table according to the communication result information, and modifies the entry of whether an interaction result is obtained to Yes.

The above pre-stored advertisement information may exist in the form of a database, for example, the pre-stored advertisement information may be an advertisement information base. A specific example of the advertisement information base is Table 2.

TABLE 2

| | | | | Contact Method | Maximum |
|---|---|---|---|---|---|
| Advertise- | Interaction | | | of the Third | Permissible |
| ment ID | Type | Position | Time | Party Platform | Interaction Frequency |
| 002 | Call | Shenzhen | 08:00-20:00 | 0755****3 | 5/day |
| 001 | Call | Shenzhen | 08:00-12:00 | 0755****1 | 3/day (for |
| | | | 12:00-20:00 | 0755****2 | example, three |
| | Call | Shanghai | 08:00-20:00 | 021*****1 | times per day) |
| | IM | Shenzhen/Shanghai | 08:00-20:00 | ********* | 5/day |

The meaning of the records in Table 2 is illustrated below with a specific example. At 08:45, the user clicks an advertisement with an advertisement ID of 001 in Shenzhen, and intends to perform information interaction with the third party platform in a call mode (for example, a conversation mode). Then, according to Table 2, when the frequency the user clicks the advertisement does not reach 3 times per day, a contact method of 0755****1 may be selected for the user to implement information interaction between the user and the third party platform.

The maximum permissible interaction frequency in Table 2 may be set by the third party platform, and the maximum permissible interaction frequency is the maximum times for which the user is permitted to interact with the third party platform in a certain period. The maximum permissible interaction frequency in Table 2 further proves that an interaction limiting condition may also be referred to as an interaction permissive condition.

The contact information of the third party platform and/or interaction limiting conditions stored in the advertisement information base may be maintained by an advertisement platform, for example, by an advertisement server and/or the advertisement client terminal. When providing advertisement content to the advertisement client terminal, the advertisement server may send advertisement information of the advertisement to the advertisement client terminal. Advertisement content of an advertisement and advertisement information of the advertisement have the same advertisement ID. The advertisement client terminal receives the advertisement content and the advertisement information, and may store the received advertisement information in the advertisement information base. When the advertisement information in the advertisement server is updated, the advertisement server may send an advertisement information update notification to the advertisement client terminal so as to update the content in the advertisement information base. When the advertisement client terminal needs to acquire advertisement information and the advertisement information base does not store the corresponding advertisement information, the advertisement client terminal may request the advertisement information of the advertisement from the advertisement server.

The advertisement information base may further include advertisement delivery information, for example, a context of advertisement delivery and a target market of delivery, which will not be illustrated in detail herein.

In a third embodiment, a method for implementing click to call interactive advertisements is provided.

First, a web page browsed includes a picture advertisement of a commodity, the picture advertisement includes two buttons, and the two buttons indicate two interaction modes of the picture advertisement, for example, click to call and click to IM. The user clicks the click to call button.

After receiving a click to call request message of the user, a web page browser of a user terminal equipment sends the request message to an advertisement client terminal. Request parameters carried in the request message may include: information about the web page browser sending the request message (for example, a service ID), a service number bearing advertisements, an advertisement ID of 001, and an interaction type of the user of click to call.

The advertisement client terminal performs the following operations after receiving the request message sent from the web page browser.

In a first operation, a search is made in advertisement information according to the advertisement ID of 001 and the interaction type of click to call in the request message, so as to obtain contact information of a third party platform and a maximum permissible interaction frequency. If the search is made in Table 2 according to the advertisement ID of 001 and the interaction type of click to call, the information obtained after search is listed in Table 3.

TABLE 3

| | | | | Contact Method | Maximum |
|---|---|---|---|---|---|
| Advertise- | Interaction | | | of the Third | Permissible |
| ment ID | Type | Position | Time | Party Platform | Interaction Frequency |
| 001 | Call | Shenzhen | 08:00-12:00 | 0755****1 | 3/day |
| | | | 12:00-20:00 | 0755****2 | |
| | Call | Shanghai | 08:00-20:00 | 021*****1 | |

In a second operation, a search is made in history interaction records according to the advertisement ID of 001 and the interaction type of click to call in the request message, so as to obtain a history interaction record of the user and the third party platform in a certain period. If the search is made in Table 1 according to the advertisement ID of 001 and the interaction type of click to call, the information obtained by search is listed in Table 4.

TABLE 4

| | | | Contact Method | | | | Whether an |
|---|---|---|---|---|---|---|---|
| Record | Interaction | Advertise- | of the Third | Interaction | | Time | Interaction |
| Number | Type | ment ID | Party Platform | State | Moment | Span/Times | Result Is Obtained |
| 02 | Call | 001 | 0755****1 | Successful | 10:35 | 3.34 min | Yes |

In a third operation, determinment is made according to the results found in the first and second operations, so as to determine whether a conversation between the user and the third party platform is permitted. Since the maximum permissible interaction frequency found in the first operation is 3 times per day, while in the history interaction record found in the second operation, the user interacts with the third party platform only once, the determinment result of the advertisement client terminal is: the conversation between the user and the third party platform is permitted, and the following fourth operation is performed.

In the fourth operation, the advertisement client terminal determines contact information of the third party platform. Since the current time is 14:00 and the position of the user is Shenzhen, the advertisement client terminal may use 0755****2 as the contact information of the third party platform in the current conversation.

In a fifth operation, the advertisement client terminal determines whether to shield user information from the third party platform according to preset user interaction policy information. If the user interaction policy information indicates that provision of the user information to the third party platform is not permitted, the advertisement client terminal determines to shield the user information from the third party platform. In this case, user information such as user contact methods and position is not provided to the third party platform.

In a sixth operation, the advertisement client terminal adds a record to a history interaction record table, so as to store information about the current conversation between the user and the third party platform in the history interaction record. For example, the record added to the history interaction record table in Table 1 is listed in Table 5.

TABLE 5

| | | | Contact Method | | | | Whether an |
|---|---|---|---|---|---|---|---|
| Record | Interaction | Advertise- | of the Third | Interaction | | Time | Interaction |
| Number | Type | ment ID | Party Platform | State | Moment | Span/Times | Result Is Obtained |
| 004 | Call | 001 | 0755****2 | | 14:00 | | No |

In a seventh operation, the advertisement client terminal triggers a terminal communication module, so as to initiate a conversation with the third party platform using the contact method of 0755****2.

The operation of the advertisement client terminal performed independent of the above operations includes: acquiring a part of information (for example, interaction result information) in the history interaction record by the advertisement client terminal from the terminal communication module. The advertisement client terminal performs the operation of acquiring the interaction result information according to a trigger condition (for example, after 10 minutes or when the user requests advertisement interaction again). The operation of acquiring the interaction result information performed by the advertisement client terminal includes: the advertisement client terminal searches for a record with whether an interaction result is obtained being empty or No in the history interaction record table, and requests interaction result information from the terminal communication module according to a contact method of the third party platform (which may further include a moment) in the found record, receives the interaction result information returned by the terminal communication module, and adds the interaction result information to a corresponding entry of the history interaction record, for example, searches for the corresponding entry in the history interaction record table according to the moment and the contact method of the third party platform in the interaction result information, and adds an interaction state and a time span in the interaction result information to the found entry, and meanwhile modifies the entry of whether an interaction result is obtained to Yes.

A specific example of adding interaction result information returned by the terminal communication module to the history interaction record in Table 5 is listed in Table 6.

TABLE 6

| | | | Contact Method | | | | Whether an |
|---|---|---|---|---|---|---|---|
| Record | Interaction | Advertise- | of the Third | Interaction | | Time | Interaction |
| Number | Type | ment ID | Party Platform | State | Moment | Span/Times | Result Is Obtained |
| 004 | Call | 001 | 0755****2 | Failed | 14:00 | 0 | Yes |

In the above embodiment described with reference to FIG. 3, the advertisement client terminal is configured to trigger the terminal communication module to establish a session with the third party platform publishing advertisements so as to implement an information interaction process, which enables the advertisement client terminal to know the service based on which the information interaction process is triggered, and enables the advertisement client terminal to acquire an overall information interaction situation without changing existing processing operations of a network-side communication module, so that the network side, for example, the advertisement server, can perform precise charging of interactive advertisements by category, and congestion at the advertisement server can be avoided. In addition, since the advertisement client terminal controls the interaction process of interactive advertisements by using history interaction records and interaction limiting conditions, the advertisement client terminal can detect and filter malicious clicks; the advertisement client terminal can shield user information such as user contact methods and the user's advertisement requirements from the network by using interaction policy information, thereby ensuring safety of the user information.

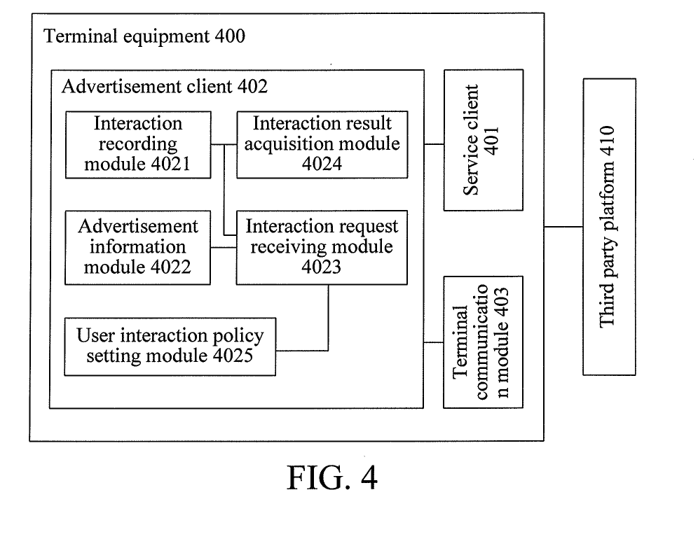

In a fourth embodiment, a system for implementing interactive advertisements is provided. A structure of the system is as shown in FIG. 4.

The system for implementing interactive advertisements in FIG. 4 includes a terminal equipment 400 and a third party platform 410 publishing advertisements. The terminal equipment 400 includes a service client terminal 401, an advertisement client terminal 402, and a terminal communication module 403. Certainly, the advertisement client terminal 402 and/or the terminal communication module 403 may also exist independent of the terminal equipment 400 (FIG. 2 is described by taking an example in which the advertisement client terminal 402 and the terminal communication module 403 are located in the terminal equipment).

The service client terminal 401 (also referred to as an application client terminal) is an entity providing applications and presenting advertisements to a user in the terminal equipment 400. When the user clicks an advertisement, a request message is sent to the advertisement client terminal 402 (for example, a received request message is sent to the advertisement client terminal) according to the clicked advertisement, so as to request information interaction between the user and the third party platform publishing advertisements. Information contained in the request message is as described in the above method embodiments. The service client terminal 401 may further record an advertisement effect, and send the advertisement effect to the advertisement client terminal 402. The advertisement effect is, for example, description of an application of an advertisement, a context of advertisement presence, a time span of advertisement presence, and an interaction behavior of a user.

The advertisement client terminal 402 receives the request message sent by the service client terminal 401, acquires a contact method of the third party platform publishing the clicked advertisement according to the information carried in the request message, and then triggers the terminal communication module 403 according to the acquired contact method of the third party platform. The advertisement client terminal 402 is a trusted entity.

After being triggered by the advertisement client terminal 402, the terminal communication module 403 performs information interaction with the third party platform according to the triggering, for example, establishes a communication connection and performs information interaction with the third party platform based on the successfully created communication connection. The terminal communication module 403 is an entity having a communication function in the terminal equipment 400, and the terminal communication module 403 may include a telephone call module, an IM client terminal, and the like. The terminal communication module 403 may further record interaction result information between the user and the third party platform, for example, record a communication connection state (whether the communication connection is successful, for example, an interaction state), a time span, and other information.

The advertisement client terminal 402 may include an interaction recording module 4021, an advertisement information module 4022, and an interaction request receiving module 4023. Optionally, the advertisement client terminal 402 may further include one or two of an interaction result acquisition module 4024 and a user interaction policy setting module 4025.

The interaction recording module 4021 is configured to store history interaction records of information interaction performed between the user and third party platforms. The information stored in the interaction recording module 4021 is configured to determine whether the user's click of the interactive advertisement is a malicious click. The information stored in the interaction recording module 4021 may exist in the form of a table, for example, the interaction recording module 4021 may store an interaction record table. A specific example of the interaction record table is Table 1.

An example of storing a record indicating that no interaction result is obtained is as follows. When receiving the request message sent from the service client terminal 401 and preparing to trigger the terminal communication module 403 or having triggered the terminal communication module 403, the interaction request receiving module 4023 in the advertisement client terminal 402 stores corresponding information (for example, an interaction type of interaction performed between the user and the third party platform, an advertisement ID, a contact method of the third party platform, and so on) in the interaction record table of the interaction recording module 4021. The specific implementation process of storing the corresponding information by the interaction request receiving module 4023 in the interaction record table is as described in the above embodiments.

An example of storing a record indicating that an interaction result has been obtained is as follows. After obtaining interaction result information from the terminal communication module 403, the interaction result acquisition module 4024 adds an interaction state, a time span/number of times, and other content to a corresponding entry in the interaction record table of the interaction recording module 4021 according to the interaction result information, and modifies the entry of whether an interaction result is obtained to Yes. The specific implementation process of obtaining the interaction result information and storing the interaction result information in the interaction record table by the interaction result acquisition module 4024 is as described in the above embodiments.

The advertisement information module 4022 stores contact information of the third party platforms and interaction limiting conditions. For each third party platform, contact information of the third party platform may include numbers at which the user can contact the third party platform in different cases, for example, a corresponding relation between at least one of a position of the user, a selected interaction type, and an interaction time period and the contact methods of third party platform.

The contact information of the third party platforms and the interaction limiting conditions may be stored in the form of a database. For example, the advertisement information module 4022 stores an advertisement information base, and a specific example of the content of the advertisement information base is listed in Table 2. The advertisement information base may be maintained by an advertisement platform, and a specific example of maintenance is as described in the above embodiments. The advertisement information base may further include advertisement delivery information, for example, a context of advertisement delivery, a target market of delivery, and so on, which will not be illustrated in detail herein.

The advertisement information module 4022 further needs to maintain advertisement information stored therein. For example, when the advertisement information in the advertisement server is updated, the advertisement server may send an advertisement information update notification to the advertisement client terminal 402, and the advertisement information module 4022 updates the advertisement information stored therein according to the notification, which is specifically as described in the above embodiments.

After receiving the request message sent from the service client terminal 401, the interaction request receiving module 4023 searches for and acquires a history interaction record of information interaction performed between the user and the third party platform according to the information carried in the request message (for example, an advertisement ID or information such as an advertisement ID and an interaction type), and searches for and acquires contact information of the third party platform (including contact methods of the third party platform at different time and positions) and an interaction limiting condition from the information stored in the advertisement information module 4022 according to the information carried in the request message (for example, the advertisement ID). The interaction request receiving module 4023 may determine whether the current click of the user is a malicious click according to the acquired information. For example, after determining that the acquired history interaction record conforms to the acquired interaction limiting condition (for example, the number of times of history interaction is smaller than a maximum permissible interaction frequency), the interaction request receiving module 4023 determines that the click is a non-malicious click, selects a contact method from the acquired contact information of the third party platform according a current position of the user, a time, an interaction type, and other information, triggers the terminal communication module according to the selected contact method (sends the contact method of the third party platform to the terminal communication module), and adds a corresponding entry to the interaction record table of the interaction recording module 4021 in response to the current click operation of the user; otherwise, the interaction request receiving module 4023 determines that the click is a malicious click, and terminates the current process of implementing the interactive advertisement.

In addition, the interaction request receiving module 4023 may request the contact information of the third party platform from a network side (for example, the advertisement server) according to the advertisement ID when it cannot acquire the contact information of the third party platform from the advertisement information module 4022. The requested contact information may be information about all contact methods of the third party platform or a contact method conforming to the requirement of the information such as the current position of the user, the current time, and the interaction type. When the requested contact information is the information about all the contact methods of the third party platform, the interaction request receiving module 4023 may determine a contact method from the requested information according to the information such as the current position of the user, the current time, and the interaction type, and further needs to store the requested information about all the contact methods in the advertisement information module 4022. Moreover, the interaction request receiving module 4023 can also request the interaction limiting condition from the network side (for example, the advertisement server) according to the advertisement ID when it cannot acquire the interaction limiting condition from the advertisement information module 4022, and further needs to store the requested interaction limiting condition information in the advertisement information module 4022.

The interaction result acquisition module 4024 acquires the history interaction record from the terminal communication module 403, and stores the history interaction record in the interaction recording module 4021. A trigger condition of acquiring the history interaction record by the interaction result acquisition module 4024 may be time triggering or event triggering. The time triggering is, for example, to acquire history interaction records from the terminal communication module 403 periodically according to a certain period. The event triggering is, for example, to acquire a history interaction record by the interaction result acquisition module 4024 from the terminal communication module 403 when the advertisement client terminal 402 receives the next request message. The history interaction record acquired by the interaction result acquisition module 4024 may be: before the current time point, corresponding content, for example, an interaction state and a time span/times, n an entry with whether an interaction result is obtained being No in the interaction record table.

The user interaction policy setting module 4025 stores interaction policy information of the user. The interaction policy information may be set when the user subscribes to an advertisement service from the advertisement platform. The interaction policy information is the information set for user information protection when the user performs information interaction with the third party platform, for example, information indicating whether contact methods of the user are permitted to be made public to the third party platform when the terminal communication module 402 calls the third party platform, and for another example, information indicating whether an IM number of the user is permitted to be made public to the third party platform when the terminal communication module 402 contacts the third party platform in the IM mode.

When the service client terminal 402 is provided with the user interaction policy setting module 4025, the interaction request receiving module 4023 may acquire the interaction policy information of the user from the user interaction policy setting module 4025 before triggering the terminal communication module 403, and determine whether to provide user information to the network side (for example, the third party platform) according to the acquired interaction policy information. If the interaction request receiving module 4023 determines not to provide the user information to the network side, the interaction request receiving module 4023 instructs the terminal communication module 403 to shield the user information in the process for triggering the terminal communication module 403; if the interaction request receiving module 4023 determines that the user information can be provided to the network side, the interaction request receiving module 4023 may not instruct the terminal communication module 403 to shield the user information in the process for triggering the terminal communication module 403. The content such as the user information is as described in the above embodiments.

In the above embodiment described with reference to FIG. 4, the interaction request receiving module of the advertisement client terminal is configured to trigger the terminal communication module to establish a connection and perform an information interaction process with the third party platform publishing advertisements, which does not change existing processing operations of a network-side communication module, avoids congestion at the advertisement server, and enables the interaction request receiving module of the advertisement client terminal to acquire an overall information interaction situation, for example, the interaction process of a certain interactive advertisement is triggered by a certain service, through the request message sent from the service client terminal as well as interaction result information obtained from the terminal communication module. Thus, the network side, for example, the advertisement server, can perform precise charging of interactive advertisements by category, for example, settle each service separately. In addition, since the interaction request receiving module of the advertisement client terminal can receive a request message requesting information interaction with the third party platform publishing advertisements, the interaction request receiving module of the advertisement client terminal can perform various processing operations on the request message, for example, the interaction request receiving module detects and filters malicious clicks and instructs the terminal communication module to shield information such as user contact methods and user's advertisement requirements from the network side. Since the advertisement client terminal can filter malicious clicks, reliable and true charging can be performed on interactive advertisements. Since the interaction request receiving module of the advertisement client terminal can instruct the terminal communication module to shield user information in the process for triggering the terminal communication module, the user information can be shielded from the network side, thereby ensuring safety of the user information.

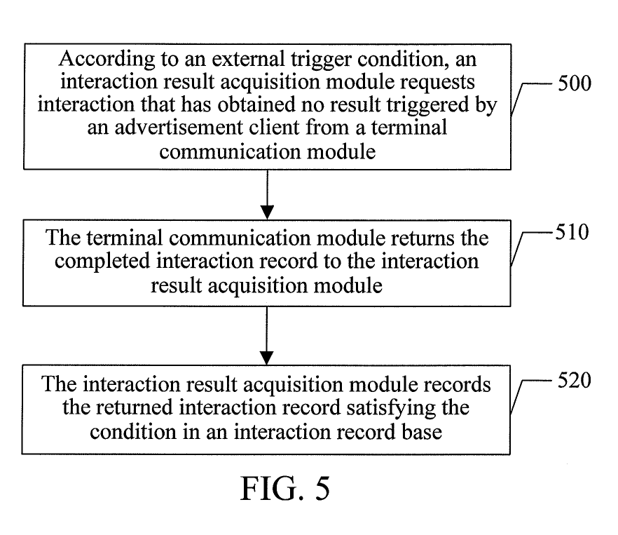

In a fifth embodiment, a process for acquiring a history interaction record by an interaction result acquisition module is shown in FIG. 5.

Referring to FIG. 5, in Step 500, the interaction result acquisition module in an advertisement client terminal requests some history interaction record information of entries indicating that no interaction result is obtained in an interaction record table from a terminal communication module according to a trigger condition. Parameters contained in a request message sent by the interaction result acquisition module to the terminal communication module may include a contact method of a third party platform, and may further include information such as a moment for an interaction result receiving module in the advertisement client terminal to trigger the terminal communication module to perform information interaction.

In Step 510, after receiving the request message sent from the interaction result acquisition module, the terminal communication module searches for corresponding interaction result information in information stored therein according to the contact method of the third party platform or information such as the interaction moment and the contact method of the third party platform, and returns the found interaction result information to the interaction result acquisition module.

In Step 520, the interaction result acquisition module receives the interaction result information, and adds the interaction result information to the interaction record table. For example, the interaction result acquisition module searches the interaction record table according to the contact method of the third party platform in the interaction result information or according to information such as the interaction moment and the contact method of the third party platform, and adds the received interaction result information to the found entry.

In the above embodiment described for FIG. 5, the interaction result acquisition module in the advertisement client terminal acquires interaction result information, so that the advertisement client terminal can acquire the interaction result information of information interaction performed between the user and the third party platform, thereby enabling the advertisement client terminal to store complete history interaction record information and enabling the interaction request receiving module to detect and filter malicious clicks.

A specific example of the terminal equipment and a specific example of the advertisement client terminal provided in the present disclosure are as described in the above system, which will not be illustrated herein again.

The interaction limiting condition in the embodiments of the present disclosure may be corresponding to a user (corresponding to an ID of the user), for example, the interaction limiting conditions corresponding to each user may be different or the same. In the embodiments of the present disclosure, for example, the interaction limiting condition and the history interaction record are corresponding to the user.

Through the above description of the embodiments, it is apparent to persons skilled in the art that the present disclosure may be implemented by software plus a necessary hardware platform, and certainly may also be implemented by hardware completely. Based on this, all or a part of the embodiments of the present disclosure can be embodied in the form of a software product. The computer software product may be stored in a storage medium such as a ROM/RAM, a magnetic disk, or an optical disk, and contain several instructions to instruct a computer equipment (for example, a personal computer, a server, or a network equipment) to perform the method described in the embodiments or in some parts of the embodiments of the present disclosure.

Although the present disclosure is described through the embodiments, persons of ordinary skill in the art should understand that modifications and variations can be made to the present disclosure without departing from the spirit of the disclosure, and such modifications and variations are covered by the appended claims of the present disclosure.

What is claimed is:

1. A method for implementing interactive advertisements, comprising:
receiving, by an advertisement client terminal, a request message sent by a service client terminal, wherein the request message is configured to request information interaction with a third party platform publishing advertisements;
acquiring, by the advertisement client terminal, contact information of the third party platform according to the request message; and
triggering, by the advertisement client terminal, a terminal communication module to perform information interaction with the third party platform according to the contact information of the third party platform.

2. The method according to claim 1, wherein the acquiring, by the advertisement client terminal, the contact information of the third party platform according to the request message comprises:
acquiring a history interaction record and an interaction limiting condition of information interaction performed between a user and the third party platform;
determining whether the history interaction record conforms to the interaction limiting condition, and if yes, acquiring the contact information of the third party platform; and
if no, terminating a current process of implementing interactive advertisements.

3. The method according to claim 2, wherein the acquiring, by the advertisement client terminal, the interaction limiting condition of information interaction performed between the user and the third party platform comprises:
searching, by the advertisement client terminal, for an interaction limiting condition corresponding to an advertisement identification (ID) in interaction limiting condition information stored in the advertisement client terminal according to the advertisement ID in the request message;
if the search is successful, using the found interaction limiting condition as the interaction limiting condition of information interaction performed between the user and the third party platform; and
if the search fails, requesting the interaction limiting condition of information interaction performed between the user and the third party platform from a network side according to the advertisement ID in the request message.

4. The method according to claim 2, wherein the history interaction record comprises:
information recorded by the advertisement client terminal in an information interaction process and interaction result information of information interaction acquired from the terminal communication module after information interaction is completed.

5. The method according to claim 4, wherein
the information recorded by the advertisement client terminal in the information interaction process comprises: an interaction type of interaction performed between the user and the third party platform, an advertisement ID, and a contact method of the third party platform; and
the interaction result information of information interaction comprises: an interaction state representing whether the information interaction is successful, and an interaction time span and/or times of message interaction.

6. The method according to claim 4, wherein the acquiring the interaction result information comprises:
acquiring the interaction result information from the terminal communication module according to at least one of a time trigger condition and an event trigger condition.

7. The method according to claim 1, wherein the acquiring, by the advertisement client terminal, the contact information of the third party platform according to the request message comprises:
acquiring, by the advertisement client terminal, the contact information of the third party platform from the request message carrying the contact information of the third party platform; or
acquiring, by the advertisement client terminal, an advertisement ID or an advertisement ID and an interaction type requiring information interaction according to the request message, and selecting a contact method from the contact information of the third party platform according to the advertisement ID or the advertisement ID and the interaction type.

8. The method according to claim 7, wherein the contact information of the third party platform comprises at least one of the following: a corresponding relation between the contact method of the third party platform and the advertisement ID, the interaction type, a time period, and position information.

9. The method according to claim 7, wherein the selecting the contact method from the contact information of the third party platform according to the advertisement ID or the advertisement ID and the interaction type comprises:
searching, by the advertisement client terminal, the contact information of the third party platform in stored information according to the acquired advertisement ID or according to the advertisement ID and the interaction type, so as to obtain a contact method of the third party platform;
if the contact information of the third party platform is found in the stored information, selecting a contact method from the stored contact information of the third party platform; and
if the contact information of the third party platform is not found, requesting the contact information of the third party platform from a network side, so as to obtain a contact method of the third party platform.

10. The method according to claim 1, further comprising:
acquiring, by the advertisement client terminal, interaction policy information of a user;
determining, by the advertisement client terminal, whether to provide information of the user to the network side according to the interaction policy information; and
when determining not to provide the information of the user to the network side, the triggering, by the advertisement client terminal, the terminal communication module to perform information interaction with the third party platform comprises:
instructing, by the advertisement client terminal, the terminal communication module to shield the information of the user in the triggering process.

11. A system for implementing interactive advertisements, comprising a service client terminal, an advertisement client terminal, a terminal communication module, and a third party platform, wherein
the service client terminal is configured to send a request message according to an advertisement clicked, wherein the request message is configured to request information interaction with the third party platform;
the advertisement client terminal is configured to receive the request message, acquire contact information of the third party platform according to the request message, and trigger the terminal communication module according to the contact information of the third party platform;
the terminal communication module is configured to perform information interaction with the third party platform according to the triggering; and
the third party platform is configured to publish the advertisement and perform information interaction with the terminal communication module.

12. A terminal equipment, comprising a service client terminal, an advertisement client terminal, and a terminal communication module, wherein
the service client terminal is configured to send a request message according to an advertisement clicked, wherein the request message is configured to request information interaction with a third party platform publishing advertisements;
the advertisement client terminal is configured to receive the request message, acquire contact information of the third party platform according to the request message, and trigger the terminal communication module according to the contact information of the third party platform; and
the terminal communication module is configured to perform information interaction with the third party platform according to the triggering.

13. The terminal equipment according to claim 12, wherein the advertisement client terminal comprises:
an interaction recording module, configured to store a history interaction record of information interaction performed between a user and the third party platform;
an advertisement information module, configured to store the contact information of the third party platform and an interaction limiting condition; and
an interaction request receiving module, configured to receive the request message, acquire the history interaction record from the interaction recording module, acquire the interaction limiting condition from the advertisement information module, and determine whether the history interaction record conforms to the interaction limiting condition, and if yes, trigger the terminal communication module according to contact methods of the third party platform acquired from the advertisement information module, and add information to the interaction recording module according to the request message and the triggering, and otherwise, prohibit information interaction.

14. The terminal equipment according to claim 13, wherein the advertisement client terminal further comprises:
an interaction result acquisition module, configured to acquire interaction result information of the information interaction from the terminal communication module, and store the interaction result information in the history interaction record of the interaction recording module.

15. The terminal equipment according to claim 12, wherein the advertisement client terminal further comprises:
a user interaction policy setting module, configured to store interaction policy information of a user;
wherein the interaction request receiving module acquires the interaction policy information of the user, and determines whether to provide information of the user to a network side according to the interaction policy information, and when determining not to provide the information of the user to the network side, instructs the terminal communication module to shield the information of the user in the triggering process.

16. An advertisement client terminal, comprising:
an interaction recording module, configured to store an interaction record of information interaction that has been performed between the advertisement client terminal and a third party platform;
an advertisement information module, configured to store contact information of the third party platform and an interaction limiting condition; and
an interaction request receiving module, configured to receive a request message sent from a service client terminal, acquire the history interaction record from the interaction recording module, acquire the interaction limiting condition from the advertisement information module, and determine whether the history interaction record conforms to the interaction limiting condition, and if yes, trigger a terminal communication module according to contact methods of the third party platform acquired from the advertisement information module, and add information to the interaction recording module according to the request message and the triggering; otherwise, prohibit information interaction, wherein the request message is configured to request information interaction with the third party platform publishing advertisements.
